(19) United States
(12) Patent Application Publication
(10) Pub. No.: US 2003/0099107 A1
(43) Pub. Date: May 29, 2003

(54) Light distributor, lighting device comprising at least one light distributor and method for the production of a light distributor

(76) Inventor: Jean-Marc Hess, Munchenstein (CH)

Correspondence Address: VENABLE, BAETJER, HOWARD AND CIVILETTI, LLP, P.O. BOX 34385, WASHINGTON, DC, 20043-9998, US

(21) Appl. No.: 10/289,381

(22) Filed: Nov. 7, 2002

(30) Foreign Application Priority Data
Nov. 23, 2001 (CH) 2001 2160/01

(51) Int. Cl. F21V 11/14; F21S 4/00

(52) U.S. Cl. 362/290; 362/217; 362/365; 362/342; 362/364

(57) ABSTRACT

A lighting device has a light source and a light distributor comprising a lamella grid or, more precisely, a reflective lamella grid. This has two strips parallel to one another and a row of lamellae which are arranged between said strips and, together with the two strips, consist of a single sheet-metal piece. Each lamella has a web and one or two limbs associated with this. Each web is furthermore associated with the two strips. The light distributor furthermore has two lateral walls which serve as lateral reflectors and are formed either by lateral sections of the sheet-metal piece forming the reflective lamella grid or by two originally separate parts connected to the reflective lamella grid. The reflective lamella grid can be produced economically from an originally flat sheet-metal piece with little work.

### BACKGROUND OF THE INVENTION

1. Field of the Invention

The invention relates to a light distributor for a lighting device, comprising two strips parallel to one another, lamellae arranged between said strips, connected to them and transverse to them, and holes present between said lamellae. Light distributors of this type are also referred to as reflector grids in practice.

2. Description of the Prior Art

A lighting device having at least one such light distributor may consist, for example, of a light, such as a ceiling light fastened directly and firmly to the ceiling, or a pendant, built-in, standard or wall light, which has an artificial light source having at least one electric lamp, for example at least one straight, tubular and/or U-shaped fluorescent lamp. The lighting device may, however, also be in the form of a luminous-band lighting device which has a rail and at least one row of lamps which follow one another along said rail and, for example, in turn consist of tubular and/or U-shaped fluorescent lamps. The lighting device is provided in particular for use in a room, for example a large office, in which at least one person works at a screen.

Known light distributors of this type have two strips, each consisting of a longitudinal wall, and a large number of lamella, each strip and each lamella consisting of a separate sheet-metal part. The strips have at least one hole for each lamella. In each of the two strips, each lamella has at least one fastening section which passes through a hole in the relevant strip and is fastened there by being bent over or locked on the strip. These known light distributors have the disadvantage that a large number of separate parts has to be produced for each light distributor. Furthermore, however, lamellae have to be arranged at the intended position between the two strips and then fastened to the strips. The production of the strips and lamellae and the assembly of these to give a light distributor are therefore complicated and expensive.

US 2001/0 048 599 A1 and the corresponding EP 1 154 200 A2 disclose light distributors having an extensive, flat or slightly curved main section which has a number of round holes and, for each of these, a projecting collar completely enclosing the hole and tapering toward the light source. These light distributors can be produced with a small height and have already proven useful but have the disadvantage that the extensive main section between the round holes and collars still has relatively large regions opaque to light. This reduces the proportion of light radiated by the lamp or the lamps of the light source directly through the holes of the light distributor, based on the total light radiated from the light source to the light distributor.

### SUMMARY OF THE INVENTION

It is an object of the invention to provide a light distributor which overcomes the disadvantages of the known light distributors. The light distributor should in particular be capable of being produced economically and should have light passages which occupy as large a part as possible of the total area of the light distributor section having light passages, so that a large proportion of the light radiated by the light source to this section of the light distributor can be radiated through the light passages.

This object is achieved according to the invention by a light distributor for a lighting device comprising at least one row of lamellae which is arranged between two strips parallel to one another and each of which has two end lamellae each arranged at one end of said row and inner lamellae arranged between said end lamellae, the strips and lamellae together consisting of a single sheet-metal piece, each lamella having a web associated with the two strips and at least each inner lamella having two limbs which are opposite one another, are associated with the web of the relevant lamella and are at least one of angled and curved away from the web.

It is also an object of the invention to provide a lighting device comprising at least one light distributor of the above-mentioned type, the lighting device having at least one lamp holder for holding at least one electric lamp of a light source in such a way that the light source radiates through the light distributor during operation.

According to still another object of the invention, a method for the production of a light distributor of the above-mentioned type is provided, in which a flat sheet-metal piece having incisions and/or holes is provided for bounding, for each limb, two lateral limb edges facing away from one another and an end limb edge, the limbs bounded thereby being angled relative to the webs.

### BRIEF DESCRIPTION OF THE DRAWING

The subject of the invention is explained below with reference to the embodiments shown in the drawings. In the drawings,

FIG. 1 shows a perspective view of a lighting device comprising a light distributor having lamellae,

FIG. 2 shows a schematic cross-section of the lighting device, which cross-section passes between lamellae,

FIG. 3 shows a longitudinal section through sections of the light distributor and of the tubular lamp of the lighting device,

FIG. 4 shows a plan view of a flat sheet-metal piece for forming the light distributor,

FIG. 5 shows a cut-out from FIG. 2, on a larger scale,

FIG. 6 shows a cut-out from FIG. 3, on a larger scale,

FIG. 7 shows a perspective view of another lighting device,

FIG. 8 shows a schematic cross-section of the lighting device according to FIG. 5, which cross-section is analogous to FIG. 2,

FIG. 9 shows a longitudinal section through sections of the lighting device and of the tubular lamp of the lighting device according to FIGS. 7, 8,

FIG. 10 shows a plan view of a flat sheet-metal piece for forming the light distributor of the lighting device shown in FIGS. 7 to 9,

FIG. 11 shows a schematic cross-section through the light distributor and the lamp of still another lighting device, which cross-section is analogous to FIG. 2,

FIG. 12 shows a cut-out from FIG. 11, on a larger scale,

FIG. 13 shows a longitudinal section through the reflective lamella grid of the light distributor according to FIG. 11,

FIG. 14 shows an end view of the reflective lamella grid,

FIG. 15 shows a cut-out from FIG. 13, on a larger scale,

FIG. 16 shows an end view of a side element of the light distributor according to FIG. 11 and

FIG. 17 shows a side view of the side element, which side view is viewed from the left side of FIG. 16.

### DESCRIPTION OF THE PREFERRED EMBODIMENTS

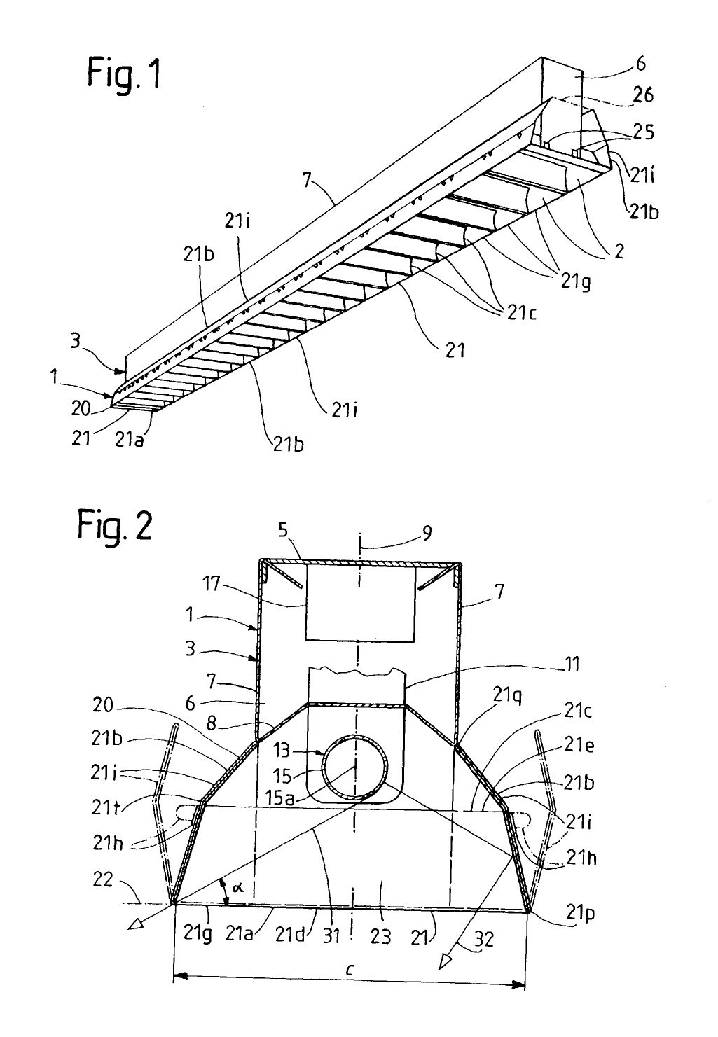

The lighting device 1 shown in FIGS. 1 and 2 consists of a light and has a housing 3 which is shown in only slightly simplified form and is held by retaining means on a room ceiling of a room of a building. The housing can, for example, be directly adjacent to the surface of the room ceiling and rigidly fastened thereto or suspended by means of flexible cables, chains or the like from the room ceiling in a movable manner a distance away from said ceiling, or may be at least partly let into a hole in the room ceiling. The housing 3 is elongated and has, for example, a base 5 and four flat, approximately vertical walls, namely two end walls 6 and two lateral walls 7 running in the longitudinal direction of the housing. The housing furthermore has a top reflector 8 which is connected to the lower edges of the two lateral walls 7 and, for example together with the lateral walls, consists of a single cohesive, multiply angled sheet-metal piece and a reflects light well and is metallized on its lower side. The housing 3 is substantially symmetrical with respect to a vertical central plane 9 in a longitudinal direction.

The housing 3 contains and holds at least one lamp holder 11, namely, for example, two lamp holders 11 located opposite one another, arranged in the vicinity of the end walls 6 and fastened to said end walls and/or to the base 5. The housing furthermore contains an artificial, electric light source 13 comprising an electric lamp 15, namely a tubular, straight, horizontal fluorescent lamp which is parallel to the lateral walls 7 and held detachably by the two lamp holders 11 and whose straight, horizontal lamp axis 15a is in the vertical central plane 9 below the lower edges of the lateral walls 7. The housing 3 furthermore contains and holds a ballast 17, for example an electronic one.

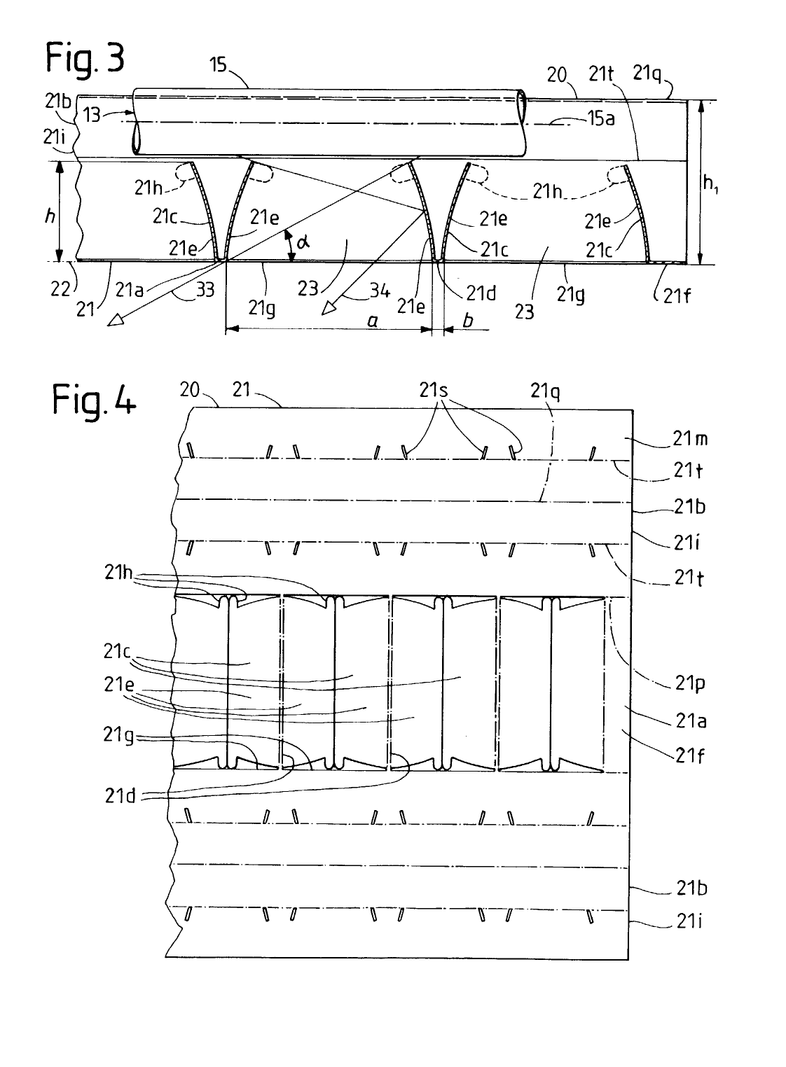

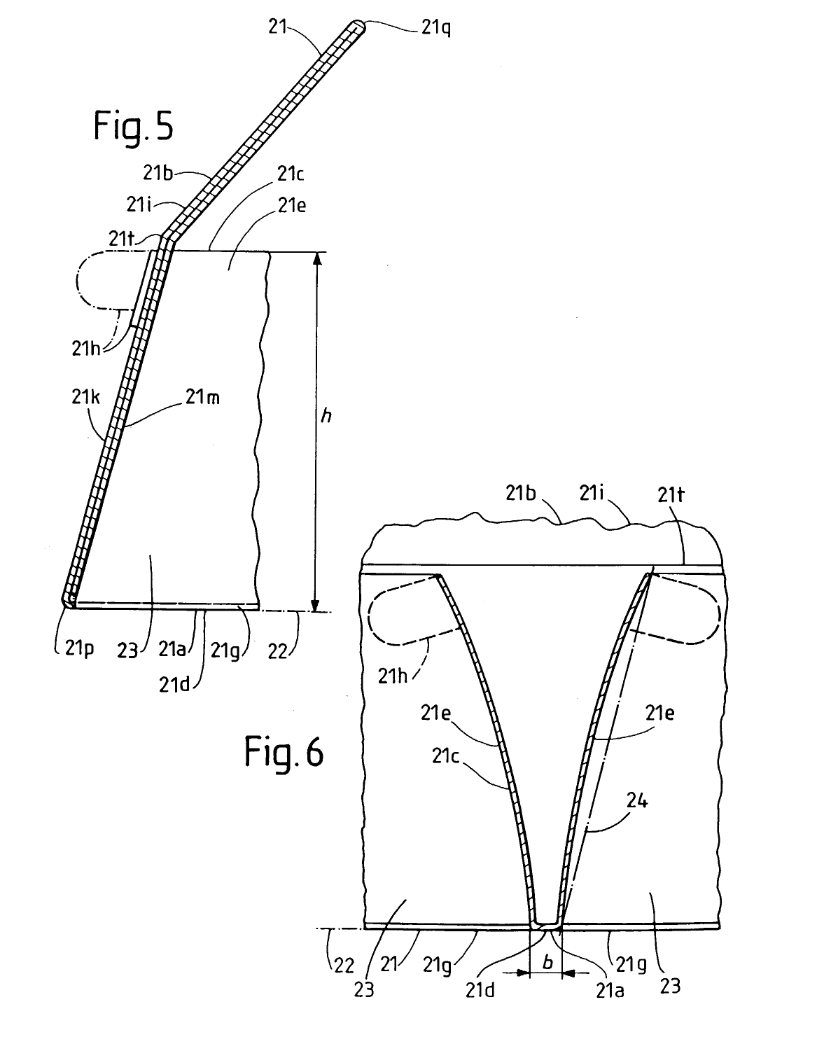

A light distributor 20 is arranged on the lower side of the housing 3 and detachably fastened to it. The light distributor 20 is formed by a lamella grid or, more precisely, reflective lamella grid 21. The light distributor 20 or reflective lamella grid 21 consists of a single, continuous, i.e. integral, multiply angled sheet-metal piece and is also shown together with the lamp 15 in FIG. 3 and in the flat, unwound state separately in FIG. 4. Furthermore, sections of the light distributor are shown in FIGS. 5 and 6. The light distributor 20 or reflective lamella grid 21 has a middle section 21a and two lateral strips 21b running on opposite sides of said middle section and along the latter. The middle section 21a and the two strips 21b are elongated and are parallel to the longitudinal direction of the housing 3 and to the lamp axis 15a. The middle section 21a has a number of lamellae 21c which form a straight row of lamellae which is parallel to the longitudinal directions of the housing 3 and of the lamp 15. In plan view, the individual lamellae 21c are transverse, namely at right angles, to the strips 21b. The lamellae 21c which are not located at one of the two ends of the row of lamellae are referred to below as inner lamellae. Each of these inner lamellae has an inner, elongated web 21d and two limbs 21e. Each inner web 21d is associated at its two web ends with one of the strips 21b and at its two longitudinal or lateral edges, running transverse and namely at right angles to the row of lamellae, with one of the limbs 21e. The lamellae located at the two ends of the row of lamellae and their webs are referred to below as end lamellae 21c and end webs 21f, respectively. Each end lamella has, for example, only a single limb 21e associated with the end web 21f. The end webs 21f have, for example, a larger dimension or width, measured in the longitudinal direction of the row of lamellae, than the inner webs 21d and are likewise associated, at their web ends extending in the direction of the row of lamellae, with the strips 21b. The webs 21d, 21f following one another along the row of lamellae, in pairs together with those edges of the strips 21b which face the middle section 21a, bound light passages 21e. Each limb 21f has two lateral limb edges which face away from one another and run away from the webs 21d or 21f associated with the limb. Each limb 21e furthermore has an end limb edge which is located at the upper free limb end which faces away from the web associated with this limb. The end limb edge is straight and parallel to the longitudinal direction of the webs. In the unwound, flat state of the sheet-metal piece forming the light distributor 20 or reflective lamella grid 21, the main sections of the lateral limb edges forming the greatest part of said edges are inclined toward one another and away from the relevant web and, for example according to FIG. 4, are smooth and slightly convex, but might instead also be straight for the most part. At least some of the limbs 21e and namely, for example, each limb of each lamella have or has, at its lateral limb edges in the vicinity of the end limb edge, in each case a fastening section 21h, namely a fastening lug 21h, which projects away from the main section of the relevant lateral edge toward the side.

The lower surfaces of the webs 21d, 21f together define a web plane 22 which, in the case of a lighting device fastened to an approximately horizontal room ceiling, forms the lower boundary of the light distributor 20 and is approximately or exactly horizontal. Each strip 21b has a lateral section 21i which forms a two-layer, lateral wall 21i and serves as a lateral reflector likewise denoted by 21i. The limbs 21e of the lamellae 21c and the walls 21i project, in a manner described in more detail, toward the same, namely upper side of the web plane 22, away from the latter, toward the base 5 of the housing 3. Each of the two lateral walls 21i has a first, outer wall section 21k and a second, inner wall section 21m. As shown particularly clearly in FIG. 5, the first, outer wall section 21k is associated, at a first, lower wall edge 21p, via angled, edge-like and/or curved connecting sections, with one end of the inner webs 21d and end webs 21f. Furthermore, each first, outer wall section 21k is associated, at a second, upper wall edge 21q, via a fold, with the second, inner wall section 21m. The second wall section 21m of each of the two walls 21i runs away from the second, upper wall edge 21q, along that side of the first wall section 21k which faces the other, opposite wall, toward the webs 21d, 21f up to at least approximately the first, lower wall edge 21p and is at least approximately adjacent, at least in parts and preferably substantially everywhere, to the first wall section 21k, so that the two wall sections 21k, 21m form an outer and inner layer, respectively, of the wall. Each of the two wall sections 21k, 21m of the two walls 21i has a slot-like hole 21s for each limb 21e of each lamella. The holes 21s of the two wall sections 21k, 21m belonging to the same wall are at least approximately flush with one another in pairs.

The two walls 21i are inclined toward one another in an upward direction away from the webs 21d, 21f and have, for example in vertical section, two flat wall parts which are connected to one another approximately to the height of the upper ends of the limbs 21e or slightly above these ends by a slightly angled and/or curved transition 21t. The wall parts located above the transitions 21t are inclined upward toward one another to a slightly greater extent than the wall parts located below the transitions 21t and thus make a slightly smaller, more acute angle with the web plane 22 than the lower wall parts. The inner surfaces of the wall parts associated at the transition 21t accordingly make an obtuse angle with one another. Otherwise, at their second upper wall edges 21q the walls 21i abut—at least approximately—the edges of the main housing part 7, at which the top reflector 8 is connected to the lateral walls 7. According to FIG. 2, the top reflector 8 has, in cross-section, three flat sections, namely a middle reflector section parallel to the web plane 22 and located above the lamp 15 and, on both sides of said reflector section, two lateral, inclined reflector sections. The two lateral reflector sections are inclined upward toward one another away from the lower edges of the lateral walls 7 and the second, upper wall edges 21q of the light distributor 20 to an even slightly greater extent than the upper wall parts of the walls 21i. The lower surface of the top reflector 8 and the inner surfaces of the walls 21i serving as lateral reflectors, which surfaces face in each case the other wall 21i, together form a light-reflecting, mirror surface which, in the vertical cross-section shown in FIG. 2, is multiply angled and more or less concave.

As shown in FIGS. 2 and in particular 5, the first, lower edges 21p of the walls 21i are located virtually directly at the free ends of the webs 21d and those edges of the light passages 21g which run in the longitudinal direction of the light distributor 20 and of the row of lamellae. The limbs 21e of the lamellae 21c rest with the smooth main sections of their lateral edges at least approximately against the walls 21i. The fastening sections or fastening lugs 21h of the limbs pass through the holes 21s approximately flush with one another in pairs and present in the wall sections 21k, 21m and are angled on the outer side facing away from the remaining parts of the limbs, so that they are adjacent to the outer surfaces of the first, outer wall sections 21k of the walls 21i and connect the limbs of the lamellae there firmly to the walls. The lamellae are thus associated on the one hand, at their lowermost points at the ends of their webs, with the two strips 21b and are moreover firmly connected, in the vicinity of the uppermost point of their limbs, by the fastening sections or fastening lugs 21h, to the walls 21i formed by lateral sections of the strips 21b. For these reasons and owing to the two-layer formation of the walls 21i, the light distributor 20 or reflective lamella grid 21 is fairly stable and dimensionally stable even when the sheet-metal piece forming it has a small sheet-metal thickness.

Each limb 21e of a lamella 21k is in general inclined away from the web 21d or 21f associated with it, upward toward the lamella adjacent to it along the row of lamellae. The limbs are slightly curved in the vertical section shown in FIGS. 3 and 6, in such a way that the opposite surfaces of two limbs belonging to lamellae adjacent to one another are concave and, for example, approximately parabolic. The two limbs 21e belonging to one and the same inner lamella 21c are accordingly inclined upward away from one another in a direction away from the web 21d of the relevant lamella.

An intermediate light transmission space 23 is present between two directly adjacent limbs 21e of two different lamellae following one another along the row of lamellae. In the vertical cross-section shown in FIG. 2 and running transverse to the row of lamellae, said space 23 is bounded by the two walls 21i which are at least approximately adjacent to the lateral limb edges of the lamellae over the total height of the lamellae. In this embodiment of the light distributor, each intermediate light transmission space 23 thus forms a light passage which is more or less closed on all sides in plan view and in horizontal sections and extends downward away from the light source 13 toward the webs 21d, 21f, both in the cross-section shown in FIG. 2 and running vertically and transversely to the row of lamellae and in the longitudinal section shown in FIG. 3 and running vertically and in the longitudinal direction of the row of lamellae.

The thickness of the sheet-metal piece forming the light distributor 20 or reflective lamella grid 21 is preferably at most 1 mm and, for example, about 0.3 mm to 0.5 mm. The dimensions of the light passages 21g measured in the longitudinal direction of the light distributor 20 and of the row of lamellae—i.e. the distance between the opposite lateral edges of two webs 21d and 21d or 21d and 21f adjacent to one another—is denoted by a in FIG. 3. This dimension a may vary within wide limits and is typically at least 15 mm, at most 100 mm and, for example, 20 mm to 60 mm. The inner webs 21d have a dimension or width, measured in the longitudinal direction of the light distributor 21 and of the row of lamellae, which is denoted by b in FIGS. 3 and 6. This dimension or width b of the inner webs is expediently at most 10 mm, preferably at most 8 mm, better at most 6 mm and preferably at least 1 mm and, for example, 2 mm to 5 mm or 6 mm. The width b of the inner webs 21d is furthermore expediently at most 25%, preferably at most 20%, better at most 15% and, for example, even only at most or about 10%, of the dimension a of the light passages. That dimension of the light passages 21g which is measured at right angles to the row of lamellae and is denoted by c in FIG. 2 is preferably at least of the same magnitude as the dimension a of the light passages and, for example, 30% to 100% greater than the dimension a. The height h of the lamellae 21c or, more precisely, of the limbs 21e of the latter, measured perpendicular to the web plane 22, is, for example, 40% to 60% of the dimension a of the light passages 21g. The lateral sections 21 or lateral walls 21i serving as lateral reflectors have a height h₁, measured perpendicular to the web plane 22, which is at least equal to the height h of the lamellae and namely greater than the height h, so that the lateral walls 21i or lateral reflectors project beyond the limbs of the lamellae. The lower and upper edges of a limb 21e which are adjacent to an intermediate light transmission space 23 together define a limb plane which is shown in FIG. 6 and denoted by 24 and makes an angle of, for example, about 70° to 80° with the web plane 22.

The light distributor 20 or reflective lamella grid 21 is detachably connected to the housing 3 by fastening means 25 indicated only schematically in FIG. 1. The fastening means 25 may have, for example, fastening members which are connected permanently to the housing 3 or light distributor 20 and can snap into one another and/or can be firmly clamped to one another and/or can be in the form of fast-action locking parts or can possibly be screwed to one another so that, for replacing the lamp 15, the light distributor can be rapidly removed from the housing and fastened thereto again. The fastening members connected permanently and firmly to the light distributor 20 may consist completely or partly of holes present in the light distributor and/or lugs associated with the light distributor, or the like. If the light distributor is fastened to the housing, it is likewise substantially symmetrical with respect to the central plane 9. The housing may furthermore be provided, at each of its two ends, with an end closure member 26 which is likewise indicated only schematically in FIG. 1 and encloses the light distributor at the ends. The end walls 6, the reflector 8, the light distributor 20 and the end closure members 26 together bound a light source chamber which contains the light source 13 and from which light can be radiated into the environment substantially only through the intermediate light transmission spaces 23 of the light distributor 20 and which is otherwise more or less opaque to light.

For the production of a light distributor 20 or reflective lamella grid 21, a flat sheet-metal piece at least generally rectangular is first produced and, for example, provided with the cuts or slot-like holes shown in FIG. 4 by punching. In particular, two lateral limb edges facing away from one another and an end limb edge are formed or bounded for each limb 21e of a lamella 21c. The end limb edges can be formed by cuts without removal of material so that the limbs of lamellae adjacent to one another more or less abut one another in the flat state of the light distributor or sheet-metal piece. On the other hand, a small amount of material is removed, namely punched out, in the case of the lateral limb edges, so that approximately triangular holes and fastening sections 21h form there in the sheet-metal piece. Furthermore, the slot-like holes 21s are punched into the sheet-metal piece. Moreover, the sheet-metal piece may also be provided, by embossing in the flat state, with grooves at which it is subsequently angled and/or folded. In any case starting from the originally flat sheet-metal piece the wall sections 21k, 21m are folded for the formation of the two-layer walls 21i and the limbs 21e of the lamellae 21c and the strips 21b or walls 21i are angled relative to the webs 21d, 21f. Furthermore, the fastening sections or fastening lugs 21a are introduced into the slot-like holes 21s of the walls in the intermediate state indicated by dash-dot lines in FIGS. 2 and 5, during final shaping of the walls 21i likewise indicated by dash-dot lines in an intermediate position in FIG. 2. Thereafter, the fastening sections or fastening lugs 21h are angled so that they occupy the positions which are drawn with solid lines in FIGS. 2 and 5 and also shown in FIGS. 1, 3 and 6 and in which they are adjacent to the outer surfaces of the walls. In this way, the light distributor 20 can be produced economically from a single sheet-metal piece in a short time and with little work.

The light distributor 20 or reflective lamella grid 21 consists, for example, of aluminum or of an aluminum alloy. The sheet-metal piece forming the light distributor has a smooth and light-reflecting, mirrored surface, for example on both sides. During the production of the sheet-metal piece, one of these two surfaces can be made particularly light-reflecting and with particularly good mirror properties by a particular surface treatment—for example by anodization and coating of the anodized surface layer with a very thin, very light-transparent protective layer. This specially treated, highly reflective surface then has better light reflectivity and better mirror properties than the other surfaces of the sheet-metal piece. For clarification, it should be noted that “mirror properties” means that light incident on the surfaces is reflected in accordance with the optical laws of reflection and not radiated back diffusely. In the formation of the light distributor 20 from an originally flat sheet-metal piece, the latter is shaped, i.e. angled and curved, in such a way that those surfaces of the limbs 21d of the lamellae which are adjacent to the intermediate light transmission spaces 23 are formed by sections of the highly reflective or better light-reflecting surface of the sheet-metal piece. This highly reflective surface then also forms the lower surfaces of the webs 21d, 21f, the outer surfaces of the first, outer wall sections 21k and especially those inner surfaces of the second, inner wall sections 21m which are adjacent to the intermediate light transmission spaces 23.

According to FIGS. 2 and 3, the lamp 18 is located above the free upper edges or end edges of the limbs 21e of the lamellae 21c, a small distance away therefrom. The lamp axis 15a and at least the greatest part of the entire lamp 15 are located below the second, upper wall edges 21q of the walls 21i of the light distributor 20. Those upper, free edges or end edges of the limbs 21e of the lamellae which face the lamp 15 together define a flat, rectangular area which is bounded on its longitudinal sides by the walls 21i of the light distributor 20 and is referred to below as the light incidence side and/or light incidence area of the middle section 21a, of its lamellae and of the entire light distributor. The lower surfaces of the webs 21d, 21f, those lower edges of the limbs 21e which are associated with the webs, and the first, lower wall edges 21p together form and define a light-radiating side and/or light-radiating area of the middle section 21a, of its lamellae 21c and of the entire light distributor, which light-radiating side and/or light-radiating area lies in the web plane 22.

When the lighting device 1 is used, the lamp 15 radiates a part of the light generated by it directly toward the light incidence side or light incidence area of the middle section 21a and, at this light incidence side or light incidence area, into the intermediate light transmission spaces 23, through the intermediate light transmission spaces 23 and through the light passages 21g and, at the latter, out of the light distributor 20 on the light-radiating side of said light distributor. The light passages 21g thus form the light emergence orifices of the light distributor. In FIGS. 2 and 3, two light beams of light radiated directly—i.e. without reflection at any surface of the light distributor 20—through the light distributor are shown and are denoted by 31 and 33. Furthermore, light radiated directly from the lamp into the intermediate light transmission spaces 23 can be reflected therein once or several times by at least one surface bounding these intermediate spaces and belonging to at least one of the walls 21i and/or to at least one of the limbs 21e. As examples of such light, a light beam 32 reflected by one of the walls 21i and a light beam 34 reflected by a limb 21e of a lamella 21c are shown in FIGS. 2 and 3, respectively. The lamp 15 may furthermore radiate light in approximately horizontal directions and/or directions inclined slightly downward relative to a horizontal plane and upward, which light is then reflected above the lamellae 21c by the inner surfaces of the walls 21i and/or by the lower surface of the top reflector 8 and/or possibly by the end walls 6 and/or other reflectors and/or reflective surfaces of the housing downward toward the light entry side of the light distributor.

The light radiated directly and without reflection and that radiated with at least one reflection by a lamella 21c and/or wall 21i through an intermediate light transmission space 23 and the light passage 21g downward out of the light distributor makes an angle α with the web plane. The intermediate light transmission spaces widen from top to bottom in such a way that this angle α is at least 25° for all possible light beams. Consequently, with an approximately horizontal position of the web plane 22, it is possible to prevent a person working at a screen set up in the usual manner in the room having the lighting device 1 from being dazzled by any light radiated from the lighting device 1 toward the screen and reflected by the latter. The light distributor 20 thus has an antidazzle effect. Furthermore, a large part of the light generated by the lamp and radiated directly or after at least one prior reflection toward the light incidence side of the middle section 21a and of the lamellae 21c is radiated through these and out of the bottom of the light distributor.

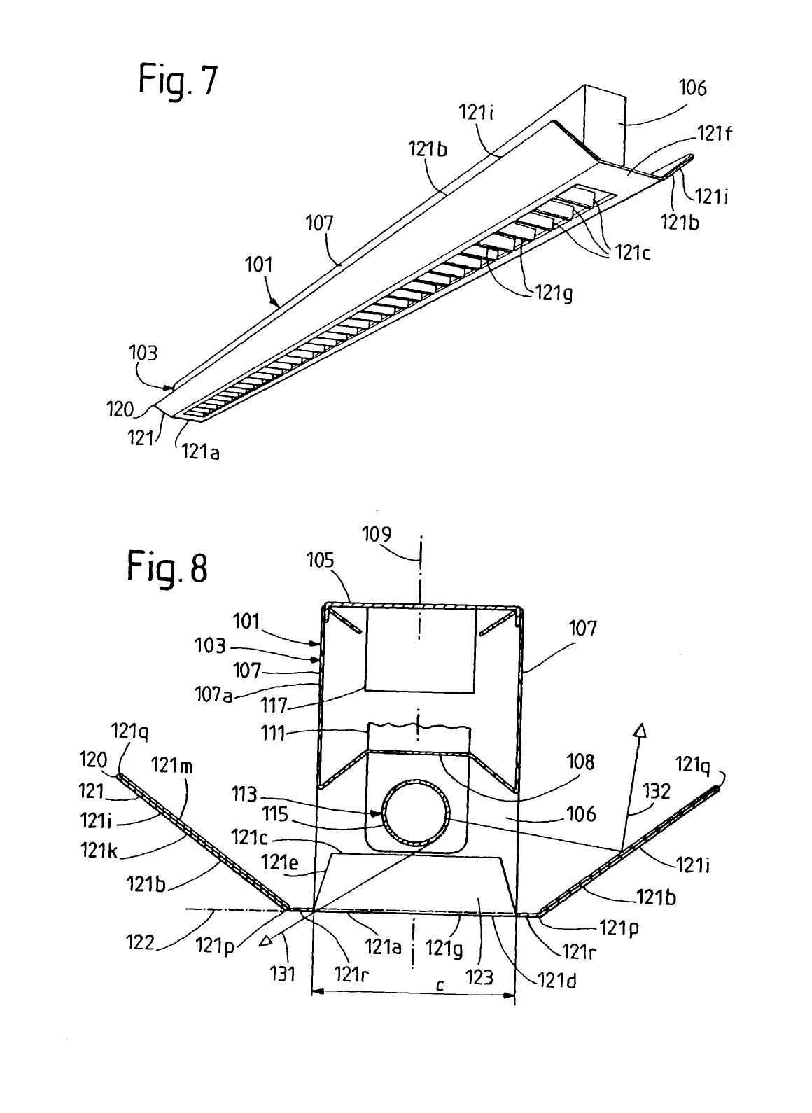

The lighting device 101 shown in somewhat simplified form in FIGS. 7 and 8 in turn has a housing 103 comprising a base 105, two end walls 106, two lateral walls 107, a reflector 108 and a vertical central plane 109 running in the longitudinal direction of the housing. The lighting device 101 furthermore has two lamp holders 111, a light source 113 with a tubular lamp 115, a ballast 117 and a light distributor 120 detachably fastened to the housing 103 by fastening means which are not shown.

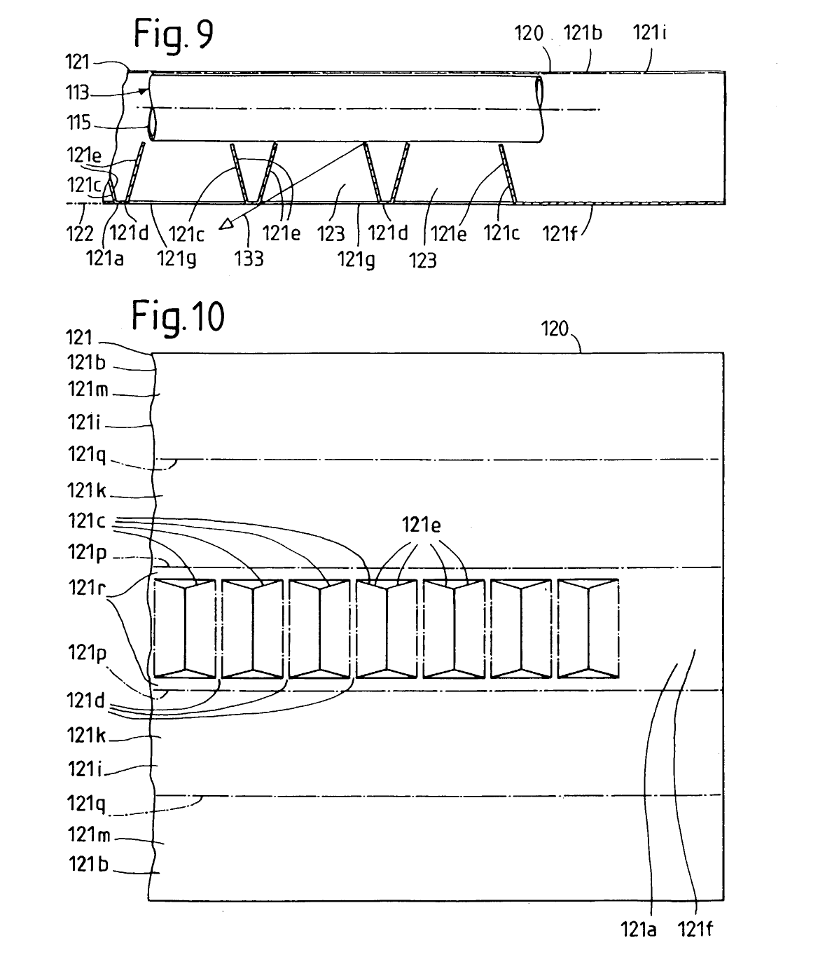

The light distributor 120 is once again formed by a one-piece lamella grid or, more precisely, reflective lamella grid 121. This in turn has a middle section 121a and two strips 121b running along its longitudinal sides. The middle section 121a in turn has inner lamellae 121c with inner webs 121d and two limbs 121e each and two end lamellae 121c with only one limb and one broader end web 121f. According to FIG. 9, the limbs 121e are inclined analogously to limbs 21e but are, for example, flat. Light passages 121g are present between the webs 121d, 121f. The webs or—more precisely—the lower surfaces of these, define a web plane 122. The strips 121b have a lateral section 121i which forms a lateral wall 121i running upward away from the web plane 122. Said wall 121i has a first, outer wall section 121k, a second, inner wall section 121m, a first, lower wall edge 121p and a second, upper wall edge 121q and once again serves as a lateral reflector 121i. In this embodiment, a narrow, strip-like connecting section 121r which lies in the same plane as the webs and may be regarded as part of the middle section 121a and/or of one of the strips 121b is present between the first, lower wall edge 121p of each wall 121i and those web ends of the webs 121d, 121f which are opposite this wall edge, and those edges of the light passages 121g which run in the longitudinal direction of the light distributor and of the row of lamellae. The width of the connecting sections 121r, measured at right angles to the longitudinal direction of the light distributor 120 and of the row of lamellae, is preferably substantially smaller than the dimension c of the light passages 121g, likewise measured at right angles to said longitudinal direction, and is preferably at least 2 mm and, preferably, at most 10 mm.

The two walls 121i of the light distributor 120 or reflective lamella grid 121 project upward beyond the limbs 121e of the lamellae 121c and preferably also slightly beyond the lamp 115 but are inclined upward away from the webs and from one another and outward away from the central plane 109. The walls 121i are, for example flat and make an angle of, for example, about 30° to 50° with the web plane 122. Free intermediate spaces are present between the walls 121i of the light distributor 120 and those outer edges of the top reflector 108 which coincide with the lower edges of the lateral walls 107. Once again, intermediate light transmission spaces 123 are present between the lamellae adjacent to one another. The lateral edges of the limbs 121e of the lamellae 121c are, however, separated from the two walls 121i by free intermediate spaces becoming larger in an upward direction. The intermediate light transmission spaces 123 are therefore no longer completely separated from one another in plan view in the light distributor 120 but are continuous between the lateral edges of the limbs 121e and the walls 121i.

For the production of the light distributor, a flat, rectangular sheet-metal piece is first formed, provided with the cuts and holes shown in FIG. 10 and then angled.

When the lighting device 101 is used, the lamp 115 can, inter alia, radiate light without reflection by the light distributor 120 through its intermediate light transmission spaces 123, as illustrated by the light beams 131 and 133 in FIGS. 8 and 9. Furthermore, light which is reflected by at least one of the limbs 121e of the lamellae 121c can be radiated through the intermediate light transmission spaces. The lamp 115 can furthermore radiate light toward the inner surfaces of the walls 121i of the light distributor 120, which light is then reflected by said light distributor and, like the light beam 132 in FIG. 8, radiated upward toward the room ceiling on which the lighting device 121 is held. The room ceiling can then radiate at least a part of this light more or less diffusely back downward. In addition, the lamp may even radiate light directly between the lower edges of the lateral walls 107 of the housing and the second, upper wall edges 121q of the walls of the light distributor 120, with a slight upward inclination, into the environment of the lighting device. The light distributor 120 is once again formed and dimensioned in such a way that all light radiated through directly or with at least one reflection by said light distributor makes an angle of at least 25° with the web plane 122. Furthermore, the strips 121b and the walls 121i formed by them ensure that no light radiated directly from the lamp 115 and no light radiated from the reflector 108 or another reflecting part of the housing 103 and the entire lighting device 101 is directed downward past the middle section 121a.

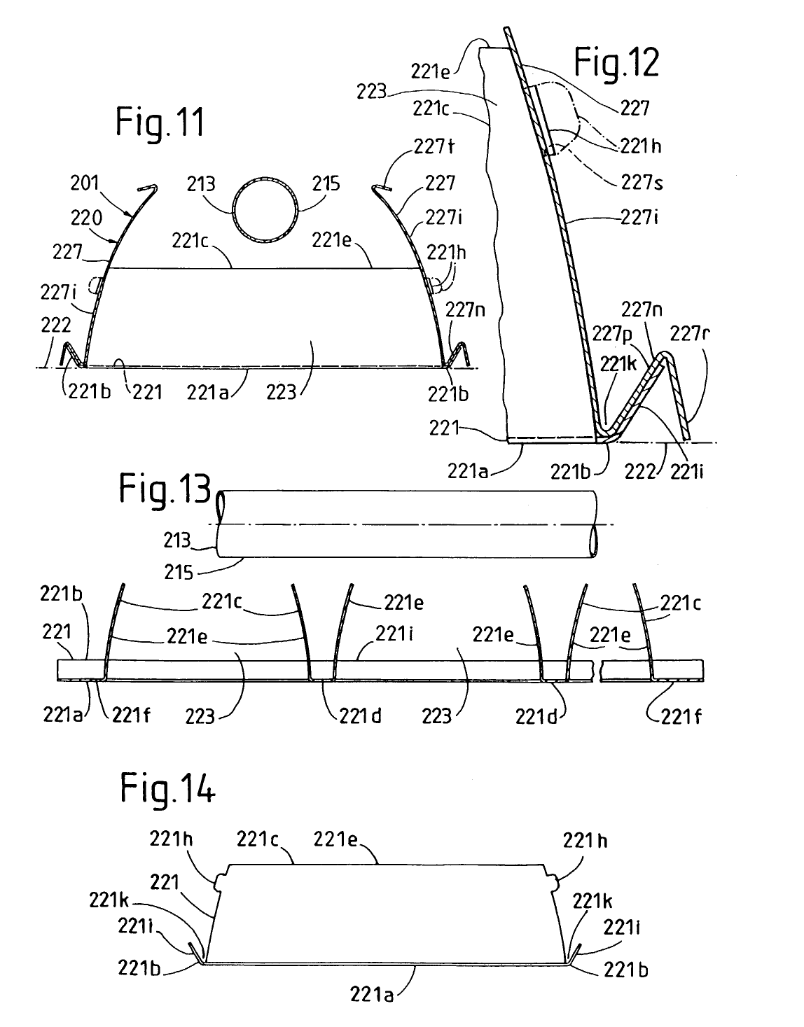

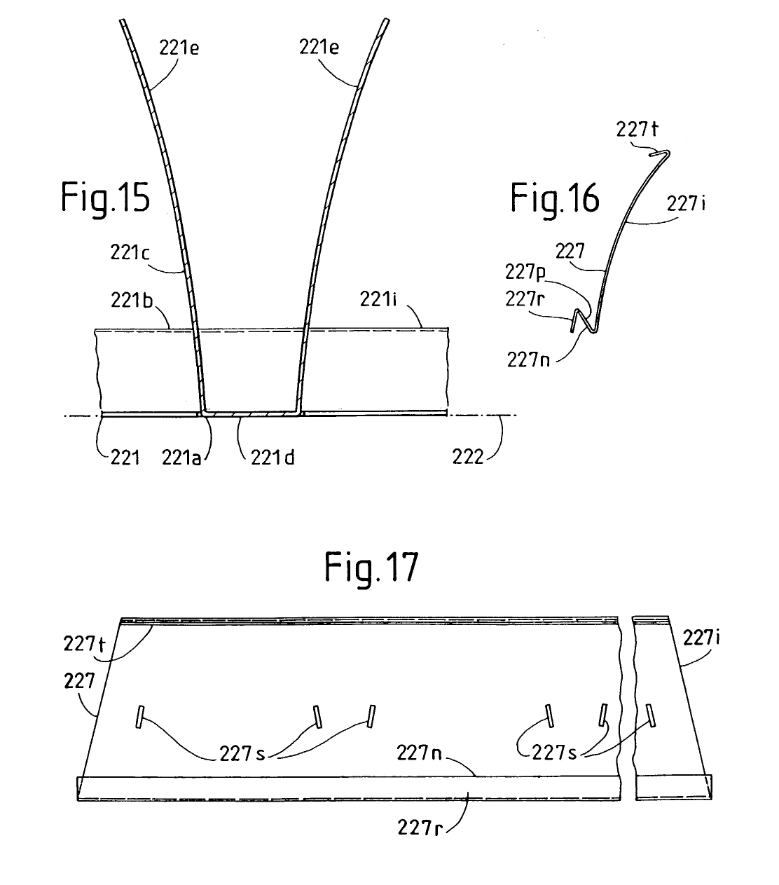

The lighting device 201 shown partly and in simplified form in FIG. 11 has a housing which is not shown and which holds an electric light source 213, comprising a tubular lamp 215, and a removable light distributor 220. In this embodiment, the light distributor 220 is composed of three originally separate, one-piece parts, namely sheet-metal pieces, i.e. a lamella grid or, more precisely, reflective lamella grid 221 and two lateral members 227. The one-piece reflective lamella grid 221 is also shown separately in FIGS. 13, 14 and 15 and once again has a middle section 221a and two strips 221b, each of which is arranged on one of the two longitudinal sides of the middle section. The middle section 221a has a row of lamellae which comprises a number of lamellae 221c. Each inner lamella 221c once again has an inner web 221d and two limbs 221e, the web once again being associated at its ends with one of the two strips 221b and, at its longitudinal or lateral edges running transversely to the row of lamellae, with the limbs. The width of the inner webs 221d may have values similar to those stated for the webs 21d and in particular may also be smaller than shown in FIGS. 13 and 15, in relation to the other dimensions of the reflective lamella grid 221. Each of the two end lamellae 221c present at one of the ends of the row of lamellae has an end web 221f and, for example, only one limb 221e associated with this. The limbs 221e of the lamellae 221c generally have shapes similar to those of the limbs 221e and, in particular in the section shown in FIG. 13 and running in the longitudinal direction of the row of lamellae, are, for example, curved similarly to the limbs 21e. Otherwise, the lateral edges of the limbs 221e are for the most part inclined upwards slightly toward one another and, for example at least for the most part, slightly convex, more or less similarly to the limbs 21e. The limbs 221e furthermore have a projecting fastening section 221h, i.e. a fastening lug 221h at each of their lateral edges.

The lower surfaces of the webs 221d, 221f once again define a web plane 222. Each strip 221b has a lateral section 221i which is shown particularly clearly in FIG. 12 and is angled and/or curved with respect to the web plane 222 and, as in the case of the limb 221e of the lamellae 221c, projects upward away from the web plane 222. The lateral sections 221i of the two strips 221b have flat main sections which are inclined outward away from one another and from the lamellae in the direction upward away from the web plane. The height of the lateral sections 221i which is measured perpendicular to the web plane 222 and starting from the latter is substantially smaller than the correspondingly measured height of the limbs of the lamellae. Each lateral section 221i, together with the lowermost regions of those lateral edges of the limbs 221e of the lamellae 221c which face said lateral section, bound a row of partial intermediate spaces which together form a more or less groove-like and/or incision-like intermediate space 221k which widens in cross-section upward away from the web plane 222 and is, for example, approximately V-shaped.

One of the two lateral members 227 is also shown separately in FIGS. 16, 17. Each lateral member 227 has a main section which forms a lateral wall 227i and/or a lateral reflector 227i of the light distributor 220. Each lateral member 227 furthermore has a retaining section 227n contiguous with the lower edge of the lateral wall 227i. Said retaining section has an inner limb 227p angled and/or curved upward away from the lower edge of the wall 227i and flat for the most part and an outer limb 227r contiguous with the upper edge of said limb 227p and once again angled and/or curved downward. The lowermost region of the wall 227i and the inner limb 227p of the retaining section 227n of each lateral member 227 project into the intermediate space 221k between one lateral edge of the limbs 221e of the lamellae and the lateral sections 221i of the reflective lamella grid 221 which are arranged there, so that each lateral member 227 touches the reflective lamella grid 221 in the relevant intermediate space 221k. At least the greatest parts of those regions of the walls 227i and retaining sections 227n of the lateral members which project into the intermediate spaces 221k fit at least approximately without play and tightly into the intermediate spaces 221k. The lateral walls 227i project upward away from the upper surfaces of the strips 221b of the reflective lamella grid 221 at least to the height of those upper ends of the limbs 221e of the lamellae 221c which form the highest points of the limbs 221e and namely beyond the upper ends of the limbs at least into the height range of the lamp 215. The height is measured from the web plane 222 perpendicular to the web plane 222. The walls 227.i of the lateral members 227 have a slot-like hole 227s for each fastening section 221h consisting of a fastening lug 221h. The two lateral members also have for example, on the upper edges of the walls 221i, edge sections 227t angled and/or curved outward.

When the light distributor 220 is assembled, each of the two lateral members 227 is inserted from above into one of the groove-like intermediate spaces 221k bounded by the limbs 221e of the lamellae 221c and one of the lateral sections 221i of the reflective lamella grid 221. The fastening lugs 221a are also pushed through the coordinated slot-like holes 227s. The lateral members 227 are, for example, slightly springy so that they can be temporarily elastically deformed and more or less snap in on insertion into the groove-like intermediate spaces 221k of the reflective lamella grid 221 and when the fastening lugs 221h are pushed into the holes 227s. The lateral edges of the limbs 221e of the lamellae 221c then rest at least approximately against the walls 221i, whereby they touch these at least in part, and preferably rest at least approximately against them along their entire length. Furthermore, the transition regions which connect the lower ends of the walls 227i to the retaining sections 227n, and the inner limbs 227p of the retaining sections 227n rest at least in parts and, for example, for the most part against the strips 221b and the lateral sections 227i formed by their outermost parts. Moreover, the outer limbs 227r of the retaining sections 227n of the lateral members 227 grip around the free edges of the lateral sections 221i. The fastening lugs 221h are angled and/or curved after being pushed through the holes 227s, so that they are adjacent to the outside of the walls 227i at least in parts. FIGS. 11 and 12 show the shapes of the fastening lugs by dash-dot lines before being bent over and by solid lines after being bent over. When the fastening lugs have been bent over, they connect the walls 227i firmly to the limbs of the lamellae 221. Because of this and because of those parts of the lateral members 227 which fit into the groove-like intermediate spaces 221k, the entire lateral members 227 are connected firmly and stably to the reflective lamella grid 221. The edge section 227t of the lateral members 227 which is present at the upper edges of the walls 227i and projects outward away from said walls may serve for the detachable connection of the light distributor 220 to the housing which is not shown and which holds the lamp 215.

An intermediate light transmission space 223 which, in that cross-section of the light distributor which is shown in FIG. 11, is bounded on both sides by the walls 227i is present between the directly adjacent limbs 221e of different lamellae 221c following one another along the row of lamellae. The reflective lamella grid 221 and the two lateral members 227 once again consist, for example, of sheet-metal pieces comprising aluminum or of an aluminum alloy. The sheet-metal pieces once again have on both sides, for example, a smooth and light-reflective, mirror surface, one of these surfaces being made highly reflective and better reflecting than the other surface by a particular treatment, analogously to the manner described for the reflective lamella grid 21. The lower surfaces of the webs 221d, 221f and especially those surfaces of the limbs 221e of the lamellae of the reflective lamella grid 221 which are adjacent to the intermediate light transmission spaces 223 should then be highly reflective analogously to the reflective lamella grids 21 and 121. In the case of the two lateral members 227, at least that surface which forms the inner surfaces of the walls 221i is then highly reflective, said inner surfaces facing one another and the lamellae. Because the reflective lamella grid 221 and the two lateral elements 227 are produced from originally separate parts, it is possible to make the inner surfaces of the walls 227i highly reflective, although only one of the two surfaces of the sheet-metal pieces is highly reflective and although the walls have only one layer.

Unless stated otherwise above, the light devices 101, 201 and their light distributors 120 and 220, respectively, may be formed similarly and may have similar properties to the lighting device 1 and the light distributor 20.

The lighting devices and their light distributors may also be modified in other ways. In particular, features of the lighting devices 1, 101, 201 and their light distributors 20, 120, 220 can be combined with one another. The curved limbs 21e and 221e of the reflective lamella grids 21, 221 could, for example, be replaced by limbs which are flat in the same way as the limbs 121e of the reflective lamella grid 121. Conversely, the flat limbs 121e could be replaced by limbs curved analogously to the limbs 21e. Furthermore, a lighting device can have more than one lamp and/or more than one light distributor. The lighting device can furthermore be formed as a standard lamp having a stand or as a wall lamp for fastening to a wall. Moreover, the walls 21i of the reflective lamella grid 21 or at least the second, inner wall sections 21m of these walls may also be angled and/or curved in other parts in vertical cross-sections, in addition to the angled and/or curved transition 21t, in such a way as to form wall parts which are angled toward one another and whose reflective inner surfaces make an obtuse angle with one another. Furthermore, the walls 121i or at least the second, inner wall sections 121m of these walls may also each be angled and/or curved once or several times so that the reflective inner surfaces of the successive wall parts make an obtuse or possibly convex angle with one another in pairs in vertical cross-sections. In addition, the walls 21i, 121i or at least their second, inner wall sections 21m, 121m may have, at least in part, continuously and smoothly curved, concave, for example approximately parabolic inner surfaces in vertical cross-sections. The shapes of the lateral edges of the limbs 221e of the lamellae 221c and the cross-sectional shapes of the walls 227i can, for example, be formed and modified similarly to the light distributor 20. Furthermore, the top reflectors 8, 108, 208 may also be at least partly curved in such a way that their lower reflective surfaces, in vertical cross-sections, are at least in part continuously and smoothly convex and, for example, approximately parabolic. If both the top reflector 8 and at least the second, inner wall sections 21m of the walls 21i serving as lateral reflectors are curved in the lighting device 1 shown in FIGS. 1, 2, the reflective inner surfaces of the walls 21i may be at least approximately smoothly and continuously contiguous with the lower surface of the top reflector 8 so that these surfaces together form, for example, an approximately parabolic surface. The same applies to the top reflector of the lighting device 201, which reflector is not shown.

In the lighting device 101 shown in FIGS. 7, 8, the distribution of the light reflected by the walls 121i upward into the environment of the lighting device 101 and this light as a proportion of all light generated by the light source 113 can be influenced within wide limits by the shape and dimensions of the reflector 108 and of the walls 121i of the light distributor 120 and also by the distances of the reflector 108 and of the light distributor 120 from one another and from the lamp.

That part of the light which is radiated from the lamps 15, 115, 215 of the light sources 13, 113, 213, directly or after at least one reflection, through the intermediate light transmission spaces 23, 123, 223 of the light distributor 20, 120, 220 may be at least 30% and preferably at least about 40% of the total quantity of light generated by the light sources 13, 113, 213, in all lighting devices 1, 101, 201. In the lighting devices 1, 201 described with reference to FIGS. 1 to 6 and 11 to 17, said part of the light is even preferably at least 50%, and for example at least or about 70% of the total quantity of light generated by the light source 13 or 213, or even more.

The light distributors may furthermore be produced from sheet-metal pieces where both surfaces are highly reflective and mirror-like and in particular also equally well light-reflecting. Particularly in this case, the second, inner wall sections 21m, 121m of the walls 21i, 121i, can be omitted and the latter can be formed as a single layer. In the light distributors 20, 220, the fastening sections 21h, 221h could be omitted in a part of the limbs 21e, 221e of the lamellae. The fastening sections could also be provided with incisions so that they have hook-like shapes and/or could be locked to the walls 21i or 227i. Furthermore, the limbs of the lamellae could also have, at their upper ends, angled end sections which are directed away from the intermediate transmission space adjacent to the relevant limb and are, for example, approximately parallel or slightly inclined to the web plane 22 or 122. These end sections of the limbs can then at least partly reflect light radiated directly from the lamp or from the reflector toward them so that, after further reflections by the reflector and/or by the lamellae, it is also radiated downward through the intermediate light transmission spaces and out of the light distributor. Moreover, a light distributor could have two or even more rows of lamellae which run parallel to one another side by side and between which a strip associated with the webs of the lamellae is present. Furthermore, the end lamellae present at the two ends of a row of lamellae could also have two limbs projecting from their web.

In the case of the reflective lamella grid 221, the strips 221b and their lateral sections 221i could be modified, for example, in such a way that the groove-like intermediate spaces 221k have a substantially flat base parallel to the web plane 222 and are more or less U-shaped and/or trapezoidal and, for example, also widen slightly in an upward direction. Furthermore, the outer limbs 227r angled downward could be replaced by, for example, edge sections possibly multiply angled and/or curved outward and/or upward.

The middle section 21a and/or 121a and/or 221a of the reflective lamella grid 21 or 121 or 221, respectively, could even be modified in such a way that the limbs of the lamellae run downward away from the webs and from the light source. In the case of the lamellae having two limbs, the two limbs belonging to the same lamella would then be inclined downward toward one another in a direction away from the webs. Furthermore, the positions and shapes of the strips 21b or 121b or 221b and of the lateral walls would, if necessary, have to be modified with respect to the middle sections 21, 121a.

What is claimed is:

1. A light distributor for a lighting device, comprising at least one row of lamellae which is arranged between two strips parallel to one another and has two end lamellae arranged at one end each of said row and inner lamellae arranged between said end lamellae, the strips and lamellae together consisting of a single sheet-metal piece, each lamella having a web associated with the two strips and at least each inner lamella having two limbs which are opposite one another, associated with the web of the relevant lamella and at least one of angled and curved away from the web.

2. The light distributor as claimed in claim 1, wherein each end lamella has at least one limb associated with its web, wherein the webs together define a web plane and wherein all limbs project on the same side of said plane.

3. The light distributor as claimed in claim 2, wherein the two strips have lateral sections which make an angle with the web plane and run away from the webs on the same side of the web plane as the limbs.

4. The light distributor as claimed in claim 3, wherein each lateral section forms a wall having a first wall section and a second wall section, wherein the first wall section is associated with the webs at a first wall edge, one of directly and via a strip-like connecting section, and with the second wall section at a second wall edge, and wherein the wall is folded at the second wall edge in such a way that the second wall section runs toward the webs from the second wall edge on that side of the first wall section which faces the other wall.

5. The light distributor as claimed in claim 4, wherein the second wall section is at least in parts at least approximately adjacent to the first wall section.

6. The light distributor as claimed in claim 4, wherein the limbs following one another along the at least one row of lamellae and belonging to different lamellae have light-reflecting surfaces facing one another and wherein the walls have light-reflecting surfaces facing one another and the limbs of the lamellae.

7. The light distributor as claimed in claim 6, wherein said light-reflecting surfaces of the limbs and walls are smooth and mirror-like.

8. The light distributor as claimed in claim 6, wherein said light-reflecting surfaces of the limbs and walls are provided with a light-transmitting protective layer.

9. The light distributor as claimed in claim 4, wherein the walls project to a height which is measured from the web plane and perpendicular to the latter and which is at least at a correspondingly measured height of a highest point of the limbs of the lamellae.

10. The light distributor as claimed in claim 4, wherein the walls project to a height which is measured from the web plane and perpendicular to the latter and which is above the highest point of the limbs of the lamellae.

11. The light distributor as claimed in claim 4, wherein each limb has two lateral limb edges which face away from one another and run away from the web associated with this limb, and wherein at least some of the limbs have, at their lateral limb edges, a fastening section which passes through a hole in one of the walls and connects the limb firmly to the relevant wall.

12. The light distributor as claimed in claim 11, wherein, on that side of the wall which faces away from the remaining part of the limb, each fastening section is at least one of angled and curved and locked to the wall.

13. The light distributor as claimed in claim 2, wherein, in addition to the sheet-metal piece forming the strips and lamellae, two originally separate lateral members are also present which run along the strips, each touch one of the strips, are firmly connected to the sheet-metal piece forming the strips and lamellae and form walls which make an angle with the web plane and are present at least in part on the same side of the web plane as the limbs of the lamellae.

14. The light distributor as claimed in claim 13, wherein each lateral member consists of a sheet-metal piece.

15. The light distributor as claimed in claim 13, wherein the two strips have lateral sections which make an angle with the web plane and run away from the webs on the same side of the web plane as the limbs and wherein each lateral member has a retaining section which is at least one of angled and curved away from the wall formed by this lateral member and which rests at least in parts against the lateral section of one of the strips.

16. The light distributor as claimed in claim 13, wherein the limbs following one another along the at least one row of lamellae and belonging to different lamellae have light-reflecting surfaces facing one another and wherein the walls have light-reflecting surfaces facing one another and the limbs of the lamellae.

17. The light distributor as claimed in claim 16, wherein said light-reflecting surfaces of the limbs and walls are smooth and mirror-like.

18. The light distributor as claimed in claim 16, wherein said light-reflecting surfaces of the limbs and walls are provided with a light-transmitting protective layer.

19. The light distributor as claimed in claim 13, wherein the walls project to a height which is measured from the web plane and perpendicular to the latter and which is at least at a correspondingly measured height of a highest point of the limbs of the lamellae.

20. The light distributor as claimed in claim 13, wherein the walls project to a height which is measured from the web plane and perpendicular to the latter and which is above a highest point of the limbs of the lamellae.

21. The light distributor as claimed in claim 13, wherein each limb has two lateral limb edges which face away from one another and run away from the web associated with this limb, and wherein at least some of the limbs have, at lateral limb edges, a fastening section which passes through a hole in one of the walls and connects the limb firmly to the relevant wall.

22. The light distributor as claimed in claim 21, wherein, on that side of the wall which faces away from the remaining part of the limb, each fastening section is at least one angled and curved and locked to the wall.

23. The light distributor as claimed in claim 1, wherein the two limbs associated with the same web are one of inclined away from one another and inclined toward one another in a direction away from this web.

24. The light distributor as claimed in claim 1, wherein the light distributor is formed and dimensioned in such a way that all light radiated through it from a light incidence side makes an angle of at least 25° with a web plane defined by the webs.

25. A lighting device comprising at least one light distributor as claimed in claim 1, wherein the lighting device has at least one lamp holder holding at least one electric lamp of a light source in such a way that the light source radiates light through the light distributor during operation.

26. A method for the production of a light distributor for a lighting device, comprising at least one row of lamellae which is arranged between two strips parallel to one another and has two end lamellae each arranged at one end of said row and inner lamellae arranged between said end lamellae, wherein the strips and lamellae together consist of a single sheet-metal piece, each lamella has a web associated with the two strips and at least each inner lamella has two limbs which are opposite one another, associated with the web of the relevant lamella and at least one of angled and curved away from the web, wherein a flat sheet-metal piece is provided with at least one of cuts and holes for bounding two lateral limb edges facing away from one another and an end limb edge for each limb, and wherein the limbs thus bounded are angled relative to the webs.
